(19) United States
(12) Patent Application Publication
(10) Pub. No.: US 2024/0000009 A1
(43) Pub. Date: Jan. 4, 2024

(54) CROP STRIPPER ROTOR WITH ALIGNMENT AND MOUNTING SYSTEM FOR STRIPPER TEETH SECTIONS

(71) Applicant: Applequist Mfg., Inc., Assaria, KS (US)

(72) Inventors: Jake Riffel, Gypsum, KS (US); Hank A. Kummer, Lindsborg, KS (US); Billy McQuillan, Gypsum, KS (US); Jeremy Hlad, Wilson, KS (US)

(21) Appl. No.: 18/216,541

(22) Filed: Jun. 29, 2023

Related U.S. Application Data
(60) Provisional application No. 63/356,931, filed on Jun. 29, 2022.

(51) Int. Cl. A01D 41/06; A01D 82/00

(52) U.S. Cl. CPC A01D 41/06; A01D 82/00

(57) ABSTRACT

A crop stripper rotor includes a plurality of stripper teeth sections and backer plates secured to a central core by threaded fasteners. The stripper teeth sections have stripper teeth that project radially outwardly from a mounting base, and the backer plates have teeth that fit behind the stripper teeth. The stripper teeth sections and backer plates are sandwiched between opposing flanges of adjacent bent sheet metal sections of the central core. An alignment and mounting system includes a pair of alignment slots in each stripper teeth section and backer plate that open radially inwardly. A first pair of threaded fasteners mate with the alignment slots to set the depth and alignment of the stripper teeth sections and backer plates relative to the central core. A second pair of threaded fasteners are inserted through the aligned mounting bores of the stripper teeth sections and the backer plates to complete the assembly.

### RELATED APPLICATION

This application claims the benefit of Applicant's U.S. Provisional Patent Application No. 63/356,931 filed on Jun. 29, 2022, the contents of which are incorporated herein by reference.

### BACKGROUND OF THE INVENTION

### Field of the Invention

The present invention relates generally to crop strippers for harvesting crops from standing plants, and in particular, to crop stripper rotors with stripper teeth sections and backer plates.

### Description of the Related Art

Crop stripper headers are attached to combines for harvesting grain. A stripper header includes a rotating stripper rotor in the front of the header with multiple rows (e.g., eight rows) of stripper teeth sections that strip grain from plants as the combine moves through a field. The stripper rotor rotates backwards relative to a direction of the combine's movement through the field. After the stripper rotor strips the grain, the grain and stripped crop material are deflected back into an auger and pan, moved to the center of the header, and fed into the feeder house of the combine for further threshing.

An advantage of a stripper header compared to a conventional header is that most of the grain is threshed within the header itself instead of within the threshing cylinder and concave of the combine. Thus, the material entering the combine to be threshed is mostly grain and chaff with very little straw and other plant material. The reduced plant material being threshed by the combine can result in a substantial increase in the capacity of the combine.

Maintaining and adjusting the stripper rotor of a conventional crop stripper header requires a tedious task of removing and replacing stripper teeth sections and backer plates from a central core of the rotor. There is a need for a stripper rotor with an improved system for mounting the stripper teeth sections and backer plates to the rotor.

### SUMMARY OF THE INVENTION

An object of the present invention is to provide an improved mounting system for mounting stripper teeth sections and backer plates to a stripper rotor of a crop stripper header.

A further object of the present invention is to provide a stripper rotor having a central core and a plurality of stripper teeth sections and backer plates attached to the central core using a combination of mounting bores and alignment slots to facilitate aligning and mounting the stripper teeth sections and backer plates to the central core.

A further object of the present invention is to provide a mounting system that facilitates and improves the efficiency of removing and reinstalling the stripper teeth sections and backer plates to the central core of a stripper header.

To accomplish these and other objects, the present invention provides a crop stripper rotor that includes a plurality of stripper teeth sections and backer plates secured to a central core by threaded fasteners. The stripper teeth sections have stripper teeth that project radially outwardly from a mounting base, and the backer plates have teeth that fit behind the stripper teeth. The stripper teeth sections and backer plates are sandwiched between opposing flanges of adjacent bent sheet metal sections of the central core. An alignment and mounting system includes a pair of alignment slots in each stripper teeth section and backer plate that open radially inwardly. A first pair of threaded fasteners mate with the alignment slots to set the depth and alignment of the stripper teeth sections and backer plates relative to the central core. A second pair of threaded fasteners are inserted through the aligned mounting bores of the stripper teeth sections and the backer plates to complete the assembly

According to one aspect of the invention, a crop stripper rotor is provided, comprising: a central core; a plurality of stripper teeth sections arranged to project radially outwardly from an outer periphery of the central core, each of the stripper teeth sections having a combination of mounting bores and alignment slots spaced along a length thereof for aligning with respective mounting holes in the central core; and a plurality of threaded fasteners extending through the mounting holes in the central core and the respective mounting bores and alignment slots in the stripper teeth sections to secure the stripper teeth sections to the central core.

According to another aspect of the invention, a crop stripper assembly is provided, comprising: a metal stripper teeth section having a plurality of stripping teeth spaced along and extending from a mounting base; a plastic backer plate having a plurality of backing teeth spaced along and extending from a backing base, the backing teeth being adapted to fit behind the stripping teeth; and an alignment and mounting system for attaching the metal stripper teeth section and plastic backer plate to a central core of a crop stripper rotor. The alignment and mounting system includes first and second alignment slots positioned between first and second mounting bores in the mounting base of the metal stripper teeth section, and first and second backer plate alignment slots positioned between first and second backing base mounting bores in the backing base of the plastic backer plate. The first and second mounting bores in the mounting base of the metal stripper teeth section are aligned with the first and second backing base mounting bores in the backing base of the plastic backer plate, and the first and second alignment slots in the mounting base of the metal stripper teeth section are aligned with the first and second backer plate alignment slots in the backing base of the backer plate

According to another aspect of the invention, a method of assembling a crop stripper assembly is provided, comprising: providing a plurality of bent sheet metal sections arranged to form a generally cylindrical shape of a central core, the bent sheet metal sections each having a flange with a plurality of mounting holes spaced along a length thereof; providing a stripper teeth section arranged to project radially outwardly from an outer periphery of the central core, the stripper teeth section having a mounting base with a combination of mounting bores and alignment slots spaced along a length thereof for aligning with respective mounting holes in the flanges of the bent sheet metal sections of the central core, the alignment slots being open radially inwardly on a radially inner facing side edge of the mounting base; inserting first and second threaded fasteners into a first pair of the mounting holes; placing the stripper teeth section into an aligned mounting position with the central core by mating the alignment slots in the mounting base with the first and second threaded fasteners to thereby align the mounting bores with a second pair of the mounting holes; and inserting third and fourth threaded fasteners into the second pair of mounting holes that are aligned with the mounting bores in the mounting base of the stripper teeth section.

Numerous other objects of the present invention will be apparent to those skilled in this art from the following description wherein there is shown and described embodiments of the present invention, simply by way of illustration of some of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the invention is made with reference to the accompanying drawings. In the drawings:

FIG. 1 is a perspective view of a crop stripper rotor according to the present invention.

FIG. 2 is an exploded perspective view of a partially assembled portion of the crop stripper rotor showing a stripper teeth section, a backer plate, and sheet metal sections of a central core.

FIG. 3 is another perspective view of a partially assembled portion of the crop stripper rotor.

FIG. 4 is another perspective view of a partially assembled portion of the crop stripper rotor.

FIG. 5 is another perspective view of a partially assembled portion of the crop stripper rotor.

### DETAILED DESCRIPTION OF THE INVENTION

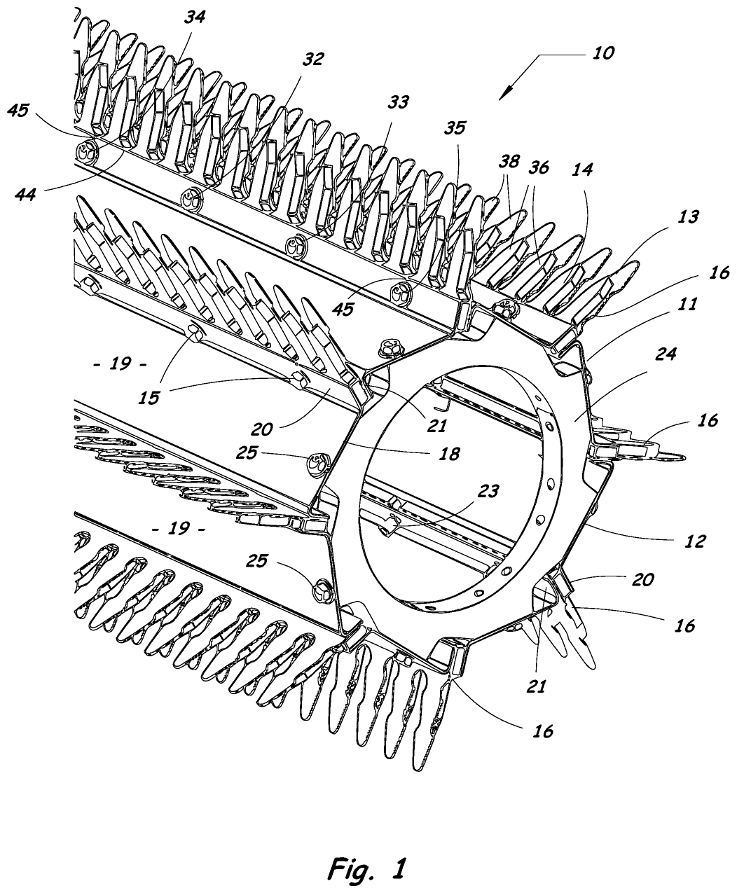

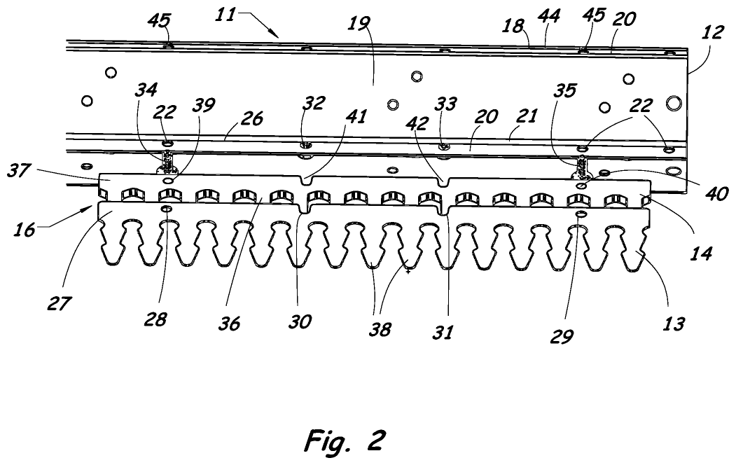

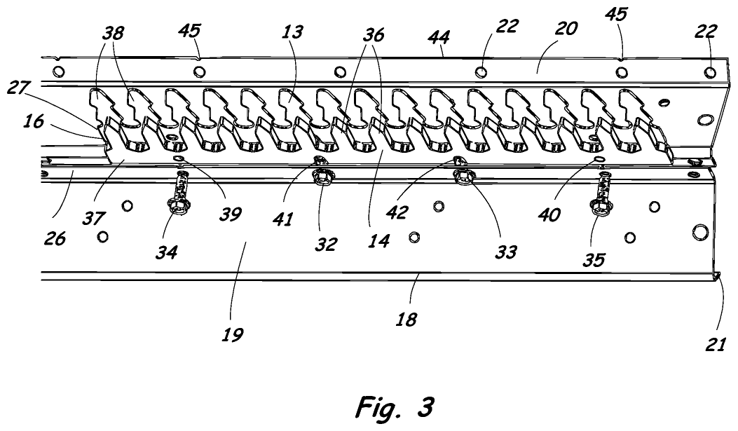

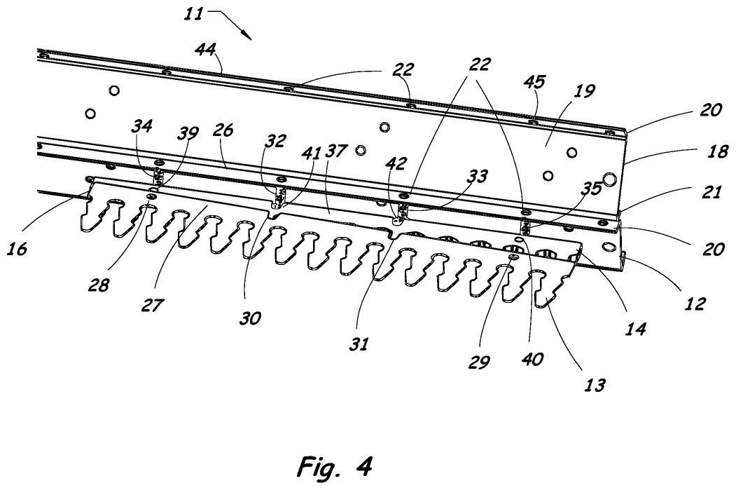

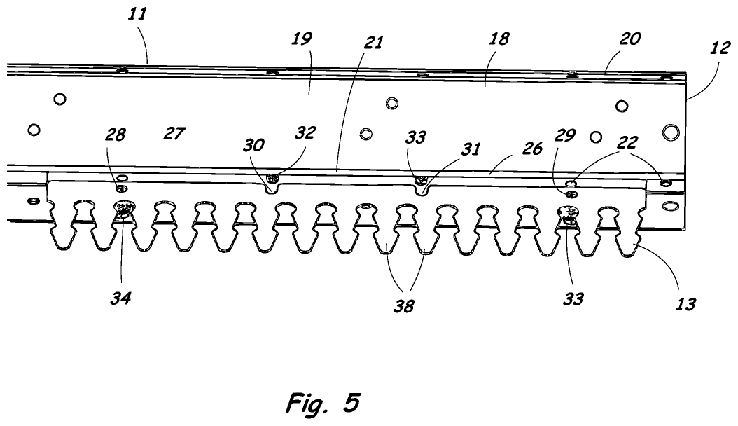

A crop stripper header 10 having a stripper rotor 11 according to the present invention will now be described with reference to FIGS. 1 to 5 of the accompanying drawings.

The crop stripper rotor 11 includes a central core 12, a plurality of stripper teeth sections 13, a plurality of backer plates 14, and a plurality of threaded fasteners 15 for securing the stripper teeth sections 13 and backer plates 14 to the central core 12.

The stripper teeth sections 13 and backer plates 14 are arranged in multiple, axially extending rows of stripper teeth assemblies 16 along the central core 12. The rows of stripper teeth assemblies 16 are angularly spaced from each other around the central core 12. Each row of stripper teeth assemblies 16 includes a plurality of stripper teeth sections 13 and backer plates 14 positioned end-to-end with other stripper teeth sections 13 and backer plates 14. The alignment and mounting system described herein can be used with each stripper teeth section 13 and its corresponding backer plate 14 to facilitate assembling the stripper teeth sections 13 and backer plates 14 to the central core 12.

The central core 12 includes a plurality of bent sheet metal sections 18 arranged to form a generally cylindrical shape. The bent sheet metal sections 18 each have a flat portion 19 and flanges 20, 21 extending in an axial direction along the side edges of the flat portion 19. The bent sheet metal sections 18 have a generally Z-shape in cross section, with a first one of the flanges 20 (i.e., the leading flange relative to a direction of rotation) extending radially outwardly from the flat portion 19, and a second one of the flanges 21 (i.e., the trailing flange relative to the direction of rotation) extending radially inwardly from the flat portion 19.

The leading flange 20 of each of the sheet metal sections 18 has a plurality of mounting bores 22 at spaced locations (e.g., approximately six inch spacing) along a length of the sheet metal sections 18. The trailing flange 21 of each of the sheet metal sections 18 has a plurality of threaded mounting holes 23 at spaced locations corresponding to the locations of the mounting bores 22 in the leading flange. The threaded mounting holes 23 can be formed by cutting threads into the sheet metal section 18 itself, or by fixing threaded structures, such as nuts, to the periphery of the mounting holes 23.

The bent sheet metal sections 18 are secured to central end hubs 24 positioned at each end of the central core 12, and central intermediate hubs (not shown) at spaced locations along the length of the rotor 11. The central hubs 24 have threaded mounting holes in mounting surfaces that are aligned with corresponding mounting bores in the flat portions 19 of the bent sheet metal sections 18 to ensure a proper fit and assembly of the central core 12. The threaded mounting holes in the central hubs can be formed by cutting threads into the central hub itself, or by fixing threaded structures, such as nuts, to the inner facing periphery of the mounting holes. Threaded fasteners 25 extend through the mounting bores in the flat portions 19 of the sheet metal sections 18 and into the threaded mounting holes in the central hub 24 to securely fasten the sheet metal sections 18 to the central hubs 24.

Once the sheet metal sections 18 are properly positioned and secured to the central hubs 24, the leading flange 20 on each sheet metal section 18 opposes the trailing flange 21 on the adjacent sheet metal section 18 with a gap 26 formed therebetween. A thickness of the gap 26 is approximately the same as the combined thickness of one of the stripper teeth sections 13 and one of the backer plates 14, thereby creating a receptacle for receiving and mounting the stripper teeth sections 13 and backer plates 14 to the central core 12.

The stripper teeth sections 13 are arranged to project radially outwardly from an outer periphery of the central core 12. Each of the stripper teeth sections 13 has a mounting base 27 with an alignment and mounting system to facilitate assembling the stripper teeth sections 13 to the central core 12. The alignment and mounting system includes a combination of mounting bores 28, 29 and alignment slots 30, 31 spaced along a length thereof for aligning with respective mounting holes 22, 23 in the flanges 20, 21 of the sheet metal sections 18 of the central core 12. The mounting base 27 of each stripper teeth section 13 is sandwiched between opposed flanges 20, 21 of the sheet metal sections 18.

The combination of mounting bores 28, 29 and alignment slots 30, 31 in each of the stripper teeth sections 13 includes first and second mounting bores 28, 29 located near first and second ends of the stripper teeth section 13, and first and second alignment slots 30, 31 spaced along the stripper teeth section 13 between the first and second bores 28, 29.

The first and second alignment slots 30, 31 are open radially inwardly on an inner facing side edge of the stripper teeth section 13. The alignment slots 30, 31 are arranged to mate with a corresponding pair of threaded fasteners 32, 33 that are pre-installed through a pair of the mounting holes 22, 23 to set a depth and alignment of the stripper teeth section 13 relative to the mounting holes 22, 23 in the central core. The alignment slots 30, 31 facilitate assembling the stripper teeth section 13 to the central core 12 by allowing two of the four threaded fasteners 32, 33 to be left in place when removing and reinstalling the stripper teeth section 13 to the central core 12.

The backer plates 14 have a plurality of backing teeth 36 spaced along and extending from a backing base 37. The backer plates 14 are arranged to fit behind the stripper teeth sections 13 with the backing teeth 36 fit behind corresponding stripping teeth 38 of the stripper teeth sections 13. The backing teeth 36 function to help support the stripping teeth 38 and reduce metal fatigue on the stripper teeth sections 13 during operation.

The backer plates 14 each have a backer plate alignment and mounting system to facilitate assembling the backer plates 14 to the central core 12. The backer plate alignment and mounting system includes a combination of backer plate mounting bores 39, 40 and backer plate alignment slots 41, 42 spaced along a length thereof. The backer plate mounting bores 39, 40 and backer plate alignment slots 41, 42 are aligned with mounting bores 28, 29 and alignment slots 30, 31 in a corresponding one of the stripper teeth sections 13.

The combination of mounting bores 39, 40 and alignment slots 41, 42 in each of the backer plates 14 includes first and second backer plate mounting bores 39, 40 located near first and second ends of the backer plate 14, and first and second backer plate alignment slots 41, 42 spaced along the backer plate 14 between the first and second backer plate mounting bores 39, 40.

The first and second backer plate alignment slots 41, 42 are open radially inwardly on an inner facing side edge of the plastic backer plate 14. The backer plate alignment slots 41, 42 are arranged to mate with the corresponding pair of threaded fasteners 32, 33 pre-installed through a pair of the mounting holes 22, 23 to set a depth and alignment of the backer plate 14 relative to the mounting holes 22, 23 in the central core 12. As with the alignment slots 30, 31 in the stripper teeth section 13, the backer plate alignment slots 41, 42 facilitate assembling the backer plate 14 along with the corresponding stripper teeth section 13 to the central core 12.

A second pair of threaded fasteners 34, 35 are inserted through the mounting holes 22, 23 in the opposed flanges 20, 21 of the sheet metal sections 18 of the central core 12 and the aligned mounting bores 28, 29 in the stripper teeth sections 13 and the aligned backer plate mounting bores 39, 40 in the backer plates 14 and tightened to finish securing the stripper teeth sections 13 and backer plates 14 to the central core 12.

An exposed edge 44 of one of the flanges 20 of the bent sheet metal sections 18 comprises visual markings 45 to indicate which threaded fasteners 32, 33, 34, correspond with the mounting holes 28, 29, 39, 40 and which threaded fasteners correspond with the alignment slots 30, 31, 41, 42. For example, the visual markings 45 can be notches cut in the edges 44 of the flanges 20 at locations corresponding to the locations of the threaded fasteners 34, 35 that need to be removed completely (i.e., the bolts corresponding to the mounting bores 28, 29 in the stripper teeth sections 13). This will allow an operator to quickly assess which threaded fasteners 34, 35 need to be removed and which threaded fasteners 32, 33 need to be left in place during assembly and disassembly operations.

A crop stripper rotor 11 with an alignment and mounting system for attaching stripper teeth sections 13 and backer plates 14 according to the present invention has been described above. A method of using the alignment and mounting system to assemble the stripper teeth sections 13 and backer plates 14 to the stripper rotor 11 will now be described.

The central core 12 of the crop stripper rotor 11 is formed by arranging the plurality of bent sheet metal sections 18 into a generally cylindrical shape, as shown in FIG. 1. The stripper teeth sections 13 are arranged with the stripper teeth 38 projecting radially outwardly from an outer periphery of the central core 12, and the mounting bases 27 of the stripper teeth sections 13 and the bases 37 of the backer plates 14 attached to the central core 12.

Each stripper teeth section 13 and its corresponding backer plate 14 has a combination of mounting holes 28, 29, 39, 40 and alignment slots 30, 31, 41, 42 for receiving the threaded fasteners 32, 33, 34, 35 extending through the mounting holes 22, 23 in the flanges 20, 21 of the bent sheet metal sections 18. In the illustrated embodiment, the combination of mounting holes and alignment slots includes a pair of mounting holes 28, 29 positioned near each respective end of the stripper teeth sections 13, a corresponding pair of mounting holes 39, 40 in the backer plates 14, a pair of alignment slots 30, 31 that open radially inwardly between the mounting holes 28, 29 in the stripper teeth sections 13, and a corresponding pair of alignment slots 41, 42 in the backer plates 14.

The crop stripper rotor 11 can be assembled by first inserting threaded fasteners 32, 33 into a first pair of the mounting holes 22, 23 in the flanges 20, 21 at positions corresponding to where the alignment slots 30, 31 in the stripper teeth section 13 and the alignment slots 41, 42 in the backer plate 14 will be located. The visual markings 45 in the flanges 20 can be used to identify which threaded fasteners 34, 35 should be removed and which should be left in place to mate with the alignment slots 30, 31, 41, 42.

The stripper teeth section 13 and backer plate 14 are then inserted into the receiving gap 26 between the opposing flanges 20, 21 of the sheet metal sections 18. The pre-installed threaded fasteners 32, 33 are received in the alignment slots 30, 31 of the stripper teeth section 13 and the alignment slots 41, 42 of the backer plate to set a depth and alignment of the stripper teeth section 13 and backer plate 14 relative to the central core 12. With the stripper teeth section 13 and backer plate 14 properly aligned, the other threaded fasteners 34, 35 can then be inserted through the mounting holes 22, 23 in the flanges 20, 21 and the mounting bores 28, 29 in the stripper teeth section 13 and the mounting bores 39, 40 in the backer plate 14. The threaded fasteners 32, 33, 34, 35 can then be tightened to fix the stripper teeth section 13 and backer plate 14 to the central core 12 to complete the assembly.

The process of attaching the stripper teeth section 13 and backer plate 14 to the central core 12 can be repeated with each stripper teeth section 13 and backer plate 14 until the stripper rotor 11 is completely assembled.

While the invention has been described in connection with specific embodiments thereof, it is to be understood that this is by way of illustration and not of limitation, and the scope of the appended claims should be construed as broadly as the prior art will permit.

What is claimed is:

1. A crop stripper rotor, comprising:
a central core;
a plurality of stripper teeth sections arranged to project radially outwardly from an outer periphery of the central core, each of said stripper teeth sections having a combination of mounting bores and alignment slots spaced along a length thereof for aligning with respective mounting holes in the central core; and
a plurality of threaded fasteners extending through said mounting holes in the central core and the respective mounting bores and alignment slots in the stripper teeth sections to secure the stripper teeth sections to the central core.

2. The crop stripper rotor according to claim 1, wherein said central core comprises a plurality of bent sheet metal sections arranged to form a generally cylindrical shape, said bent sheet metal sections each having flanges extending in an axial direction along side edges thereof with a plurality of said mounting holes formed in said flanges, and said stripper teeth sections each have a mounting base sandwiched between two of said flanges.

3. The crop stripper rotor according to claim 2, wherein said threaded fasteners are threaded bolts received in threaded structures that are fixed to one of the two flanges that sandwich the mounting base of the stripper teeth section.

4. The crop stripper rotor according to claim 2, wherein an exposed edge of one of said flanges of said bent sheet metal sections comprises visual markings to indicate which threaded fasteners correspond with the mounting bores or which threaded fasteners correspond with the alignment slots.

5. The crop stripper rotor according to claim 1, wherein said combination of mounting bores and alignment slots includes first and second mounting bores located near first and second ends of the stripper teeth section, and first and second alignment slots spaced along the stripper teeth section between said first and second mounting bores.

6. The crop stripper rotor according to claim 5, wherein said first and second alignment slots are open radially inwardly on an inner facing side edge of said stripper teeth section and are arranged to mate with a pair of said threaded fasteners extending through a pair of said mounting holes to set a depth and alignment of the stripper teeth section relative to the mounting holes in the central core to facilitate assembly of the stripper teeth section to the central core.

7. The crop stripper rotor according to claim 1, further comprising a plurality of plastic backer plates adapted to fit behind said stripper teeth sections, each of said backer plates having a combination of backer plate mounting bores and backer plate alignment slots spaced along a length thereof aligned with the mounting bores and alignment slots in one of said stripper teeth sections.

8. The crop stripper rotor according to claim 7, wherein said combination of backer plate mounting bores and backer plate alignment slots comprises first and second backer plate mounting bores located near first and second ends of the backer plate, and first and second backer plate alignment slots spaced along the backer plate between said first and second backer plate mounting bores.

9. The crop stripper rotor according to claim 8, wherein said first and second backer plate alignment slots are open radially inwardly on an inner facing side edge of said plastic backer plate and are arranged to mate with a pair of said threaded fasteners extending through a pair of said mounting holes to set a depth and alignment of the backer plate relative to the mounting holes in the central core to facilitate assembly of the backer plate along with a corresponding one of said stripper teeth sections to the central core.

10. The crop stripper rotor according to claim 1, wherein said plurality of stripper teeth sections comprise multiple rows of stripper teeth assemblies extending axially along said central core, said rows of stripper teeth assemblies being angularly spaced from each other around said central core, and each of said rows of stripper teeth assemblies comprising at least a first stripper teeth section and a first plastic backer plate positioned end-to-end with a second stripper teeth section and a second plastic backer plate, respectively, with each of said first and second stripper teeth sections and said first and second plastic backer plates having a combination of mounting bores and alignment slots spaced along a length thereof for aligning with respective mounting holes in the central core.

11. A crop stripper assembly, comprising:
a metal stripper teeth section having a plurality of stripping teeth spaced along and extending from a mounting base;
a plastic backer plate having a plurality of backing teeth spaced along and extending from a backing base, said backing teeth being adapted to fit behind said stripping teeth; and
an alignment and mounting system for attaching the metal stripper teeth section and plastic backer plate to a central core of a crop stripper rotor, the alignment and mounting system comprising first and second alignment slots positioned between first and second mounting bores in the mounting base of the metal stripper teeth section, and first and second backer plate alignment slots positioned between first and second backing base mounting bores in the backing base of the plastic backer plate, said first and second mounting bores in the mounting base of the metal stripper teeth section being aligned with said first and second backing base mounting bores in the backing base of the plastic backer plate, and said first and second alignment slots in the mounting base of the metal stripper teeth section being aligned with said first and second backer plate alignment slots in the backing base of the backer plate.

12. The crop stripper assembly according to claim 11, wherein said mounting base of the metal stripper teeth section has a radially inner facing side edge, and said first and second alignment slots are open radially inwardly on said inner facing side edge of said mounting base.

13. The crop stripper assembly according to claim 12, wherein said backing base of said backer plate has a radially inner facing side edge, and said first and second backer plate alignment slots are open radially inwardly on said inner facing side edge of said backing base.

14. A method of assembling a crop stripper assembly, comprising:
providing a plurality of bent sheet metal sections arranged to form a generally cylindrical shape of a central core, said bent sheet metal sections each having a flange with a plurality of mounting holes spaced along a length thereof;
providing a stripper teeth section arranged to project radially outwardly from an outer periphery of the central core, said stripper teeth section having a mounting base with a combination of mounting bores and alignment slots spaced along a length thereof for aligning with respective mounting holes in the flanges of the bent sheet metal sections of the central core, said alignment slots being open radially inwardly on a radially inner facing side edge of said mounting base;
inserting first and second threaded fasteners into a first pair of the mounting holes;
placing said stripper teeth section into an aligned mounting position with said central core by mating said alignment slots in the mounting base with said first and second threaded fasteners to thereby align the mounting bores with a second pair of the mounting holes; and
inserting third and fourth threaded fasteners into the second pair of mounting holes that are aligned with the mounting bores in the mounting base of the stripper teeth section.

15. The method according to claim 14, further comprising tightening said first, second, third and fourth threaded fasteners to fix said stripper teeth section to said central core.

16. The method according to claim 14, further comprising:
providing a plastic backer plate having a plurality of backing teeth adapted to fit behind said stripping teeth and extend from a backing base, said plastic backer plate having a combination of backer plate mounting bores and backer plate alignment slots that correspond with the mounting holes and alignment slots in the stripper teeth section; and
placing said plastic backer plate behind said stripper teeth section into a mounting position with said central core by mating said backer plate alignment slots with said first and second threaded fasteners and thereby aligning the backer plate mounting bores with the mounting bores in the stripper teeth section and the second pair of mounting holes in the central core;
wherein said step of inserting third and fourth threaded fasteners comprises inserting said third and fourth threaded fasteners through the mounting holes in the central core, the mounting bores in the stripper teeth section, and the backer plate mounting bores.

17. The method according to claim 16, wherein said step of providing a stripper teeth section comprises providing a plurality of stripper teeth sections that each include a combination of mounting bores and alignment slots and corresponding plastic backer plates.

18. The method according to claim 14, wherein said mounting bores comprises first and second mounting bores located near first and second ends of the stripper teeth section, and said alignment slots comprise first and second alignment slots spaced along the stripper teeth section between said first and second mounting bores.

19. The method according to claim 18, wherein said backer plate mounting bores comprises first and second backer plate mounting bores located near first and second ends of the backer plate, and said backer plate alignment slots comprise first and second backer plate alignment slots spaced along the backer plate between said first and second backer plate mounting bores.

20. The method according to claim 14, further comprising providing visual markings along an exposed edge of at least one of said flanges of said bent sheet metal sections to indicate which threaded fasteners correspond with the mounting bores and which threaded fasteners correspond with the alignment slots, and leaving the threaded fasteners corresponding with the alignment slots loose within their respective mounting bores when removing the stripper teeth section to facilitate reassembling the stripper teeth section to the central core.
